(19) United States
(12) Patent Application Publication
(10) Pub. No.: US 2006/0287821 A1
(43) Pub. Date: Dec. 21, 2006

(54) Computer rearview mirror

(76) Inventor: William Lin, San Jose, CA (US)

Correspondence Address: BACON & THOMAS, PLLC, 625 SLATERS LANE, FOURTH FLOOR, ALEXANDRIA, VA, 22314, US

(21) Appl. No.: 11/152,167

(22) Filed: Jun. 15, 2005

(51) Int. Cl. G01C 21/26

(52) U.S. Cl. 701/213; 701/200

(57) ABSTRACT

A computer rearview mirror includes a casing, a transparent member, a video display, an electronic unit and an information processing unit. The electronic control unit has at least one CPU (central processing unit) and memory means. The information processing unit has at least one function module, each providing a specific function. The CPU controls the operation of each function module. The computer rearview mirror has the CPU and other systems installed therein to form a multipurpose electronic product that provides processor and multimedia functions.

### BACKGROUND OF THE INVENTION

1. Field of the Invention

The present invention relates generally to a vehicle rearview mirror and more particularly to a computer rearview mirror.

2. Description of the Related Art

Regular rearview mirrors in cars, trucks, bus and any of a variety of motor vehicles are so arranged that the driver can see traffic approaching from behind, ensuring a safety driving. Rearview mirrors with electronic display means have been developed for multiple purposes. These dual-usage or multipurpose rearview mirrors may be used with a video camera so that the driver can see traffic approaching from behind as well as surrounding conditions when reversing the car, preventing collision or hitting a person accidentally. These conventional dual-usage or multipurpose rearview mirrors have an electronic display means incorporated into the mirror. Normally, the device is used as a mirror. However, under the user's control, the internal electronic image display means of the rearview mirror displays images. These dual-usage or multipurpose rearview mirrors are seen in U.S. Pat. Nos. 5,936,231, 5,940,120, 6,052,166; 6,142,933, 6,229,192, 6,326,613 and 6,402,328.

Following fast development of scientific technology, computer and other high technologies have been intensively used in every field. These high technologies can be employed to vehicle rearview mirrors, adding different functions to the vehicle rearview mirrors.

### SUMMARY OF THE INVENTION

It is one objective of the present invention to incorporate a computer CPU and other related systems incorporated into a rearview mirror, thereby forming a compact, intelligent, internet connectable, multipurpose rearview mirror.

Technically, the computer rearview mirror of the present invention comprises a casing, a transparent member, and a video display, an electronic control unit, and an information processing unit. The electronic control unit comprises a CPU (central processing unit) and memory means. The information processing unit comprises at least one function module controllable by the CPU of the electronic control unit.

By means of the electronic control unit and the information processing unit, the rearview mirror is not simple a mirror for enabling the driver to see traffic approaching from behind. Indeed, the rearview mirror works as a sophisticated electronic product.

### BRIEF DESCRIPTION OF THE DRAWINGS

FIG. 1 is a schematic exploded view of a computer rearview mirror according to the present invention.

FIG. 2 is a system block diagram of the computer rearview mirror according to the present invention.

FIG. 3 is a functional block diagram of the computer rearview mirror according to the present invention.

FIG. 4 is a block diagram of the GPS navigation system of the computer rearview mirror according to the present invention.

FIG. 5 is an image transmitting/receiving, video telephone functional block diagram of the computer rearview mirror according to the present invention.

FIG. 6 is a car failure examination functional block diagram of the computer rearview mirror according to the present invention.

### DETAILED DESCRIPTION OF THE INVENTION

The computer rearview mirror in accordance with the present invention has a CPU and related peripheral devices and system installed in a vehicle rearview mirror, thereby forming an intelligent multipurpose rearview mirror, and allowing the rearview mirror to be used as a multipurpose electronic product while maintaining the function of allowing the driver to see traffic approaching from behind.

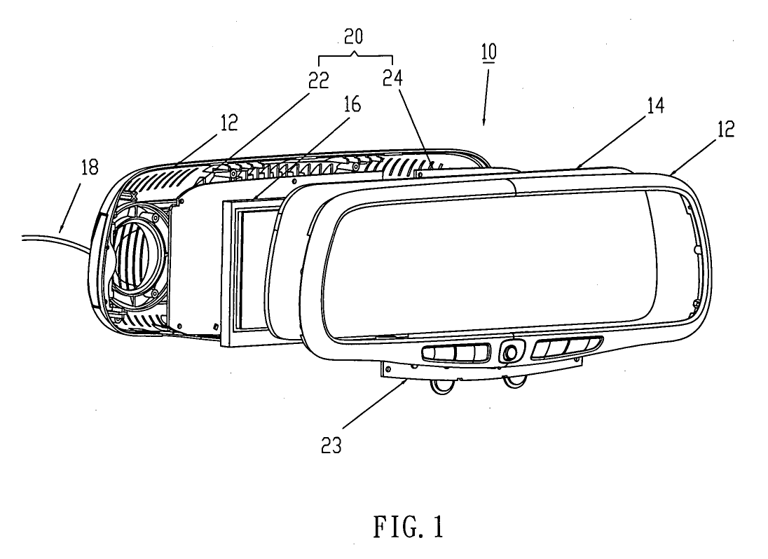

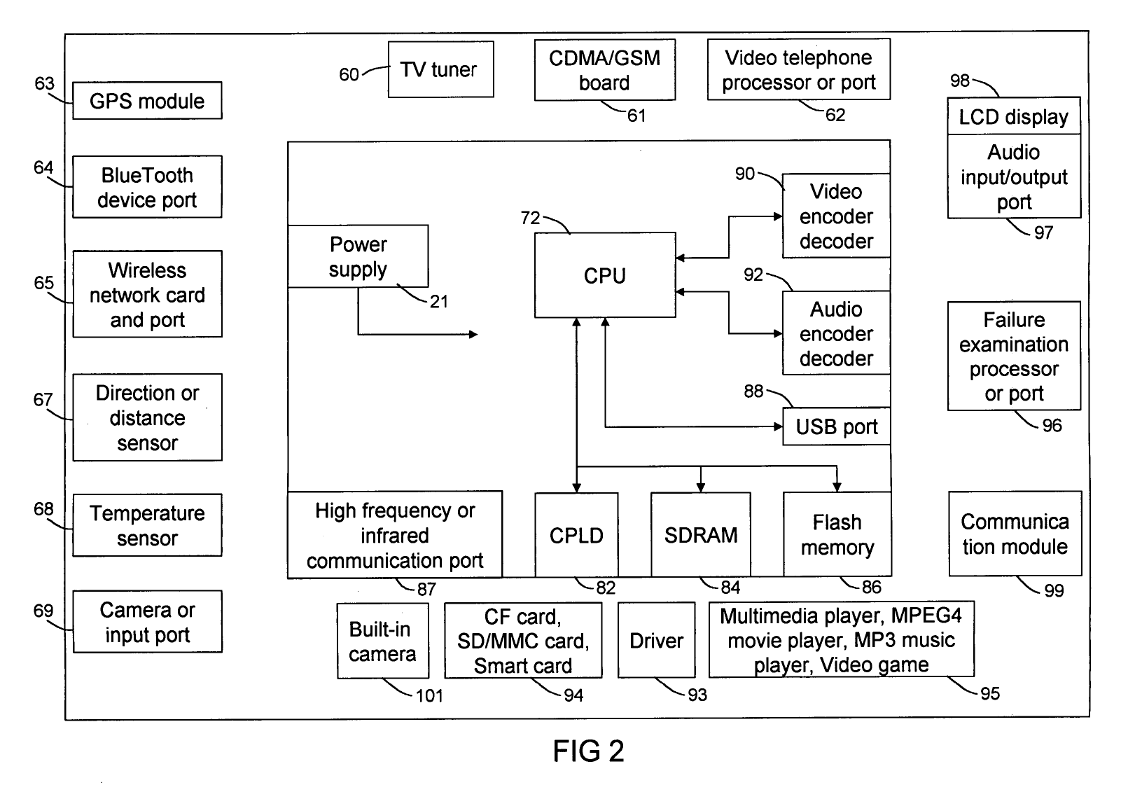

Referring to FIG. 1, a computer rearview mirror 10 is shown comprising a casing 12 (including a front cover shell and a rear cover shell), a transparent member 14, a video display 16, an electronic control unit 20, and information processing means (not shown). The video display 16 can be a color LCD, high clarity mini monitor, OSD, LCD, LED digital display or graphic display. The computer rearview mirror 10 has an electric wire 18 connected to power supply 21 (see FIG. 2). Power supply 21 passes through switch and control means to control on/off status of the electronic system. The electronic control unit 20 according to this embodiment comprises a main board 22, a keypad 23, and a control circuit board 24. The main board 22 and control circuit board 24 of the electronic control unit 20 have installed therein peripheral interfaces, function modules and processors. The aforesaid information processing means includes operating system, the necessary application programs and data. Therefore, the rearview mirror is equipped with a full computer system.

The computer rearview mirror 10 comprises a CPU, memory means (RAM, ROM, Flash Memory, SDRAM, etc.), an image recording and information processing system, a language processing system, a LCD image display system, and USB ports, and can be mounted with a built-in hard disk and an infrared transmitter or attached with any of a variety of memory cards including CF card and SD/MMC card. The computer rearview mirror 10 can use a global positioning system, wireless network transmission or bluetooth transmission techniques, and other related systems and peripheral apparatus to provide real-time traffic information, emergency aid service, remote car inspection service, mobile internet service, GPS satellite navigation service, auto positioning service, in-mirror computer, office system with multiple office software, GSM/CDMA wireless telephone, videophone, wireless network system, or alarm system with two-way landmark information transmission capability, command system, or to form a sophisticated game machine. The computer rearview mirror 10 can display all car status information, enabling the driver to understand the conditions of the car on the real time. Further, through the control keys or a remote controller, the user can control and obtain many other services.

Referring to FIG. 2, one or more CPUs 72 can be installed in the main board 22 and/or control circuit board 24 of the electronic control unit 20 of the computer rearview mirror 10. The CPU 72 can be a microprocessor, digital signal processor, or other suitable processor.

The electronic control unit 20 and information processing means of the computer rearview mirror 10 have multiple interfaces or specific processors or modules. For example, the computer rearview mirror 10 has a built-in or attached TV tuner 60, a built-in or connected CDMA or GSM chip board 61 interface, a videophone processor or interface 62, a GPS module 63, a built-in BlueTooth and device interface 64, a built-in wireless network card and interface 65, and a built-in camera lens or camera lens input interface 69. The computer rearview mirror 10 can also be equipped with a direction or distance sensor 67, a temperature sensor 68, or other electronic devices.

The computer rearview mirror 10 can realize CPLD (complex programmable logic device) 82 programming. The peripheral storage devices 80 include a SDRAM 84, a flash memory 86, and other suitable memories or storage devices.

The electronic control unit 20 and information processing means of the computer rearview mirror 10 further comprise communication and input/output ports, for example, high-frequency or infrared communication port 87 and USB port 88. Communication and input/output ports can be series and/or parallel ports, and/or other suitable ports. Communication and input/output ports can be mounted on the inside of the computer rearview mirror 10 used for connection with peripheral apparatus for the computer rearview mirror 10 and other devices.

The CPU 72 or electronic control unit 20 of the computer rearview mirror 10 can support video encoder decoder 90, AV encoder decoder 92.

The computer rearview mirror 10 further comprises peripheral apparatus including CD-ROM driver, DVD driver, or other driver 93. The driver 93 can be read only, or can be writable. The peripheral apparatus further include interface cards 94 such as CF card, SD/MMC card and SMART card, and other data storage and reading devices.

The entertainment module 95 of the computer rearview mirror 10 can be MP3, MPEG4 or other AV encoder decoder functions supportable by the game machine and the electronic control unit 20 and the information processing means.

The computer rearview mirror 10 further comprises a car failure examination processor and interface 96 for enabling the computer rearview mirror 10 to receive and display information of car conditions such as velocity, temperature, and engine speed for failure examination.

The AV input/output system of the computer rearview mirror 10 comprises at least one AV input/output interface 97 for input/output of audio and video signals. For example, the AV input/output system of the computer rearview mirror 10 can output images and voices to other monitors, or Audio and video signals from other AV signal source can be inputted into the display of the present system for display.

The computer rearview mirror 10 is interconnectable with other LCD monitors 98.

The computer rearview mirror 10 further comprises a communication module 99, for example, patrol communication module to provide the related functions.

The computer rearview mirror 10 further comprises a built-in camera lens 101, which works in the same way as the following external camera lens 100 for taking images or pictures.

Based on the aforesaid statement, the computer rearview mirror 10 can have the processors, modules and interfaces shown in FIG. 2 be mounted therein so that the computer rearview mirror 10 can provide sophisticated multimedia functions and intelligent services.

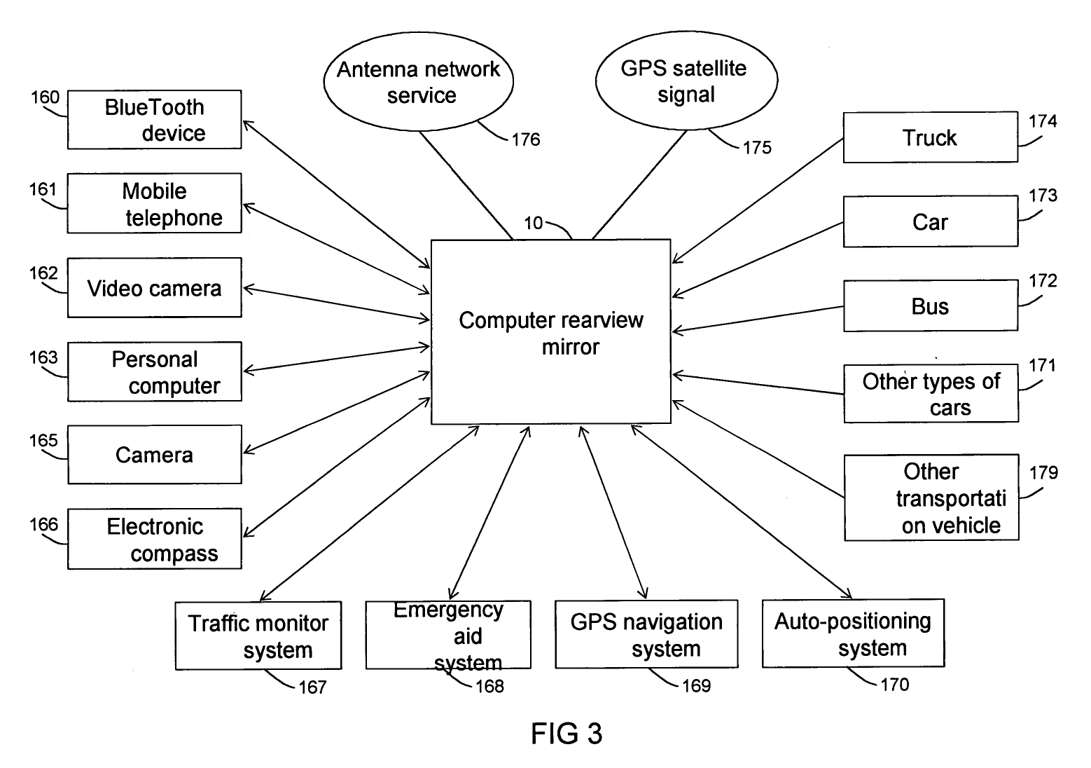

As shown in FIG. 3, the computer rearview mirror 10 is interconnectable with many external apparatus, for example, BlueTooth apparatus 160, mobile telephone processor 161, video camera 162, personal computer 163, camera 165, and etc. Through these external apparatus, the computer rearview mirror 10 has the related functions.

By means of sophisticated processing and communication functions, the computer rearview mirror 10 realizes traffic status monitoring system 167, emergency aid system 168, GPS navigation system 169, and auto positioning system 179.

The computer rearview mirror 10 can receive GPS satellite signal 175, thereby forming a GPS application system to provide wireless network service 176.

The computer rearview mirror 10 can be used in a truck 174, car 173, bus 172, or any of a variety of other motor vehicles 171 and transportation vehicles 179 including ships.

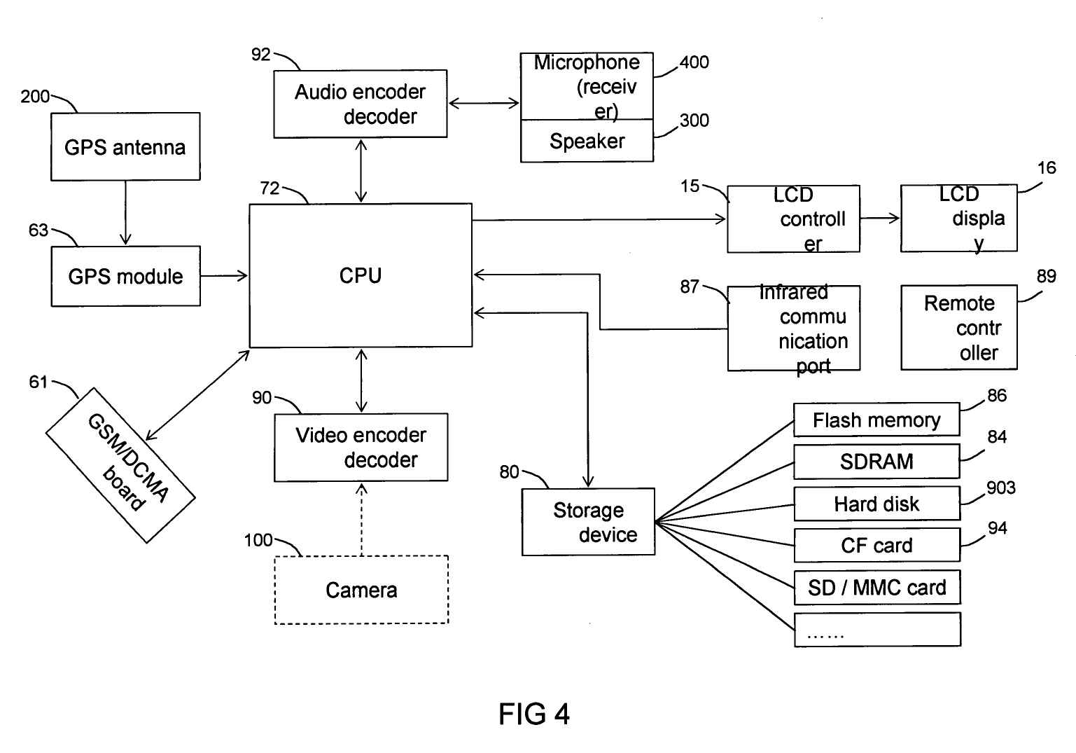

FIG. 4 shows the computer rearview mirror 10 works as a GPS satellite navigation system.

The computer rearview mirror 10 has a GPS satellite receiving antenna 200 built therein or connected thereto for receiving satellite signal. Satellite signal entered the GSP module 63 to provide landmark information and to further match with the map data and navigation software system in the storage device 80 for processing through the CPU 72 for further display on the LCD monitor 16 subject to the operation of the LCD controller 15, and therefore the driver can see the related map and traveling azimuth through the LCD monitor 16 during driving. Through the audio encoder decoder 92, the computer rearview mirror 10 gives language notes. The map data storage device 80 can be a flash memory 86, SDRAM 84, driver 93 supportive hard disk 903, interface card 94 such as CF card, SD/MMC card, or SMART card, or any of a variety of other storage means.

The voices produced by the computer rearview mirror 10 can be outputted through a speaker 300. The speaker 300 is a part of the voice transmission system of the computer rearview mirror 10. Voice command from the subscriber and other information can pass through one or multiple microphones (receiver) 400 to the computer rearview mirror 10. Voice signal from the processing system can also be received by the computer rearview mirror 10. Audio devices such as the speaker 300 can provide sound effects when displaying images. Voice data from the microphone (receiver) 400 or other audio systems is processed through the audio encoder decoder 92 to provide a clear sound effect, so that the GPS satellite navigation system provides complete functions: GPS satellite navigation positioning, electronic map browsing and inquiry, intelligent traveling route planning full-course voice note or real-time voice recording.

The computer rearview mirror 10 can be equipped with a remote controller 89 to control the operation of the GPS satellite navigation system through the infrared communication port 87 or an audio transmission port. Further, the remote controller 89 can also control other systems of the computer rearview mirror 10 such as video telephone system or failure examination system.

When equipped with the GPS satellite navigation system, the computer rearview mirror 10 can provide the following functions:

Positioning: through the GPS antenna to receive satellite signal for processing by the internal system of the computer rearview mirror 10, the current location (altitude and latitude coordinates) is accurately pointed out. When matched with the corresponding GIS, the corresponding location on the map shown on the LCD monitor is marked out.

Speed test: By means of GPS to receive and calculate satellite signal, the current driving speed is obtained and displayed on the LCD monitor.

Display of track: GPS's track logging function can record every road traveled and the distance traveled, and can start “return” function to guide you back home via the traveled route.

Self navigation: By means of map data in the storage device or information of destination, telephone number, website address, house number inputted from the remote controller or by hand-writing, the system automatically search the best way to guide the driving with clear voice notes, so as to realize GPS navigation function.

Based on GPS technology, the computer rearview mirror 10 can be equipped with a GSM or CDMA chip board 61 to provide a mobile telephone communication function. BlueTooth technology can be employed to exchange information and transmit data within the effective range.

The computer rearview mirror of the present invention can also realize the following functions:

Security function: When the motor vehicle encountered an emergency condition or is stolen, the system can produce a call signal to the control center or the owner of the motor vehicle manually or automatically so that the control center or owner of the motor vehicle can take the necessary measures rapidly. The system can be controlled to listen-in, turn off the ignition switch, or lock the door of the motor vehicle.

Auto-alarm function: When an unexpected condition such as traffic accident or stealage happened, the system automatically starts the alarm system to call the control center or the owner of the motor vehicle. Upon receipt of the alarm signal, the control center or owner of the motor vehicle can immediate take the necessary steps.

Traffic control function: The command center can check the geographic location and or the traffic condition of the site and other related information actively so that the person in the command center can guide the motor vehicle subject to the driver's request, and direct the motor vehicle to change to the best path.

Hand-free function: Because the present invention has incorporated therein GSM or CDMA technology, the computer rearview mirror 10 can be used as a telephone for communication, When driving the car, the driver can dial a telephone number, pick up the telephone, hang up the telephone, or adjust the volume of the voice by voice without using the hand, Through the microphone and speaker system in the computer rearview mirror or the car, a full duplex hand-free function is achieved.

Information inquiry function: Authorized subscriber can use the telephone or internal communication system to search vehicle status information recorded by the control center as well as to browse Internet information.

The computer rearview mirror 10 comprises a built-in video camera 101, and can be connected with one or multiple external video cameras 100. The external video camera 100 can be installed in the rear side of the car to pick up the traffic condition behind the car. Alternatively, the external video camera 100 can be installed in the front or lateral side of the car, or mounted on the inside of the car. If to mount the external video camera 100 on the inside of the car, dashboard (either the part facing the front side of the car or the part facing the inside of the car), rear window (facing the traffic condition behind the car), side window (facing the outside of the car), back seat area, etc. The video cameras 100, 101 can be connected to the computer rearview mirror 10 by cables or through a wireless network. The images obtained through the video cameras 100, 101 are processed through the video encoder decoder 90. By means of the video cameras 100, 101, the computer rearview mirror 10 can proceed with car internal as well as car external monitoring and store monitored image data in a hard disk or memory card, and can also provide an on-site evidence pickup function. A CCD (charge-coupled device) card may be installed in the driver's room to pick up images. The subscriber can also send obtained images to the control center wirelessly for further use as on-site evidence.

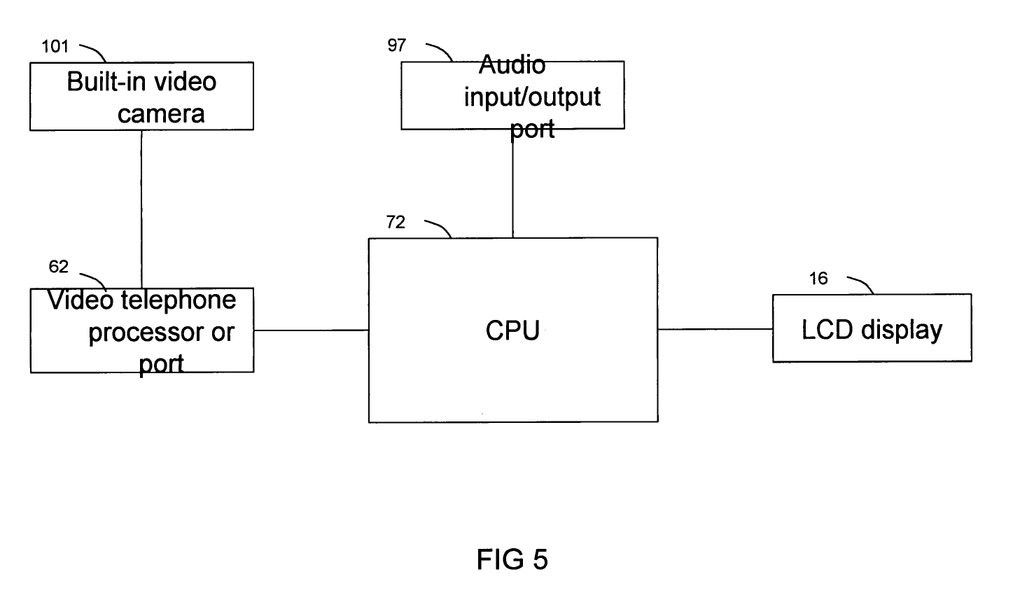

The computer rearview mirror 10 also provides image transmission and receiving and video telephone functions. As shown in FIG. 5, the built-in video camera 101 of the computer rearview mirror 10 can be connected to a video telephone processor or interface 62 through a communication line. The video telephone processor or interface 62 is connected to the CPU 72, which has connected thereto the aforesaid AV input/output port 97 and LCD monitor 16. Audio and video signals received from the V input/output port 97 and the built-in video camera 101 are transmitted to the LCD monitor 16 for output. Therefore, the computer rearview mirror 10 can transmit voice and image data from one place to another, achieving video telephone function, i.e., the computer rearview mirror 10 can receive and transmit images, monitor images, storing images, and recording and reproducing images.

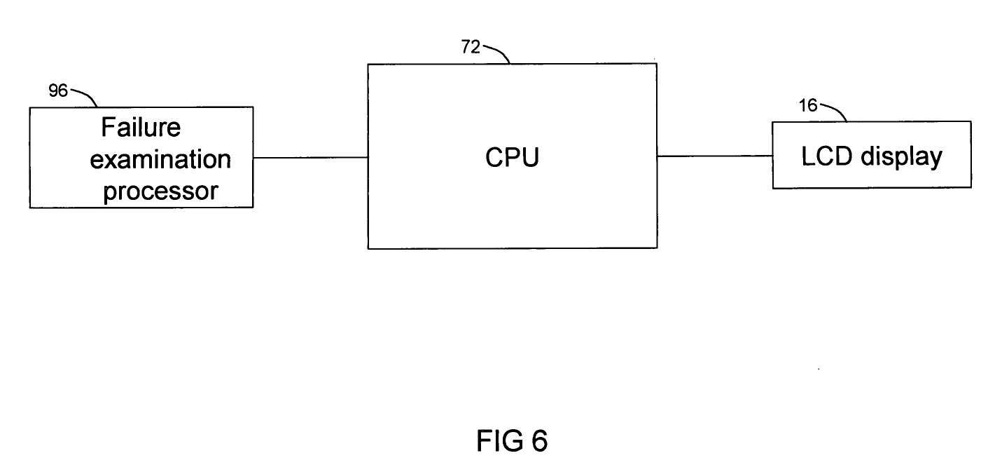

The operation of the computer rearview mirror 10 to proceed with car failure examination function is outlined hereinafter with reference to FIG. 6. The electronic control unit 20 of the computer rearview mirror 10 has installed therein a car failure examination processor and interface 96, which is electrically connected to the CPU 72. The CPU 72 transmits examination data from the car failure examination processor and interface 96 to the LCD monitor 16 for display. Further, error codes and other related data can be sent to the repair center so that the repair engineer can prepare the necessary tools and accessories subject to the received error codes before going to the job site. During car failure auto examination process, the computer rearview mirror 10 can display, control, transmit and examine the related data, and make the necessary management, or allow the driver to handle the case.

The computer rearview mirror 10 can have a built-in wireless communication module to send and receive audio and video data, providing wireless application functions.

The computer rearview mirror 10 can also provide a game function, i.e., the computer rearview mirror 10 can start the game program that is stored in the hard disk 903 or interface card such as CF card, SD/MMC card, SMART card 94. Through the wireless network, the computer rearview mirror 10 can also play on-line games.

Through the wireless network, the computer rearview mirror 10 can download music and movies, i.e., the subscriber can download MP3 music and MPEG4 movies, and can update software programs.

The computer rearview mirror 100 can also be used as a car blackbox function (tachograph) to record completely and accurately car traveling data, such as actual geographic location of the car, car internal and external conditions and voices, accidents, traveling tacks, and to store recorded data in a hard disk or mobile data storage device for further reproduction. The computer rearview mirror 100 can also analyze traffic accidents or give a warning signal to advise the driver to reduce the speed when overdrive. The computer rearview mirror 100 can also record every start time of the car, the mileage traveled, the time traveled, the maximum speed, the duration of every maximum speed. The computer rearview mirror 100 can also be connected with a burglar-alarm system. It can also process different data, display car working conditions, proceed with self-test function, as well as monitor car speed, engine speed, water temperature, oil pressure, fuel volume, fuel consumption, battery voltage, and etc. The computer rearview mirror 10 can also record a variety of data including driving speed, geographic location of the car, condition of car electric system and brake system, temperature of engine, oil pressure, etc.

The computer rearview mirror 10 can also receive TV signal through the TV tuner 60, and the received TV signal will be processed and controlled by the CPU 72 for output through the LCD monitor 16 and the speaker 300, allowing the user to enjoy TV programs.

Therefore, the video display of the present invention can display any of a variety of data obtained through different input/output devices or data sources. Input/output devices and data sources include but not limited to TV program received through a TV antenna, GPS or electronic map, video monitor for recording and transmitting continuous real-time images or pictures. Computer synthesized images and data stored in floppy disks, hard disks, CD ROM, CF card or other storage devices can be sent to any of a variety of video and audio devices through a wireless network for data processing.

The computer rearview mirror has switch and control means to control the corresponding functions or devices. These switch and control means include keys and switches that can be provided at the lower, bottom, or back side of the computer rearview mirror. The keys include number keys, alphabetic keys, and function keys. They can also be provided in the form of the entry keys of a telephone. The keys can be prepared in the form of a keypad. Alternatively, these switch and control means can be prepared in the form of a remote controller. The switches include power switch, volume control switch, brightness control switch, satellite positioning control switch, VCD/DVD switch, video telephone switch, or other function switch keys or knobs.

The remote controller of the computer rearview mirror can control the GPS navigation system, traffic condition monitoring system, video telephone, built-in computer functions, locking/unlocking of car windows, airbag, car lights, car battery power supply, etc. The remote controller can be an infrared remote controller, wireless remote controller, voice control device, TV remote controller, computer remote controller, audio system remote controller, or car remote controller.

Except the GPS antenna, the computer rearview mirror of the present invention can use a wireless antenna such as AM antenna, FM antenna, TV antenna, cell phone antenna, local antenna, or any of a variety of other antennas. Different antennas enable different communication apparatus to use with different RF frequencies so as to obtain a better communication signal. Of course, a full-frequency antenna can be used with different communication apparatus.

What is claimed is:

1. A computer rearview mirror comprising a casing, a transparent member, and a video display, wherein the computer rearview mirror further comprises an electronic control unit and an information processing unit, said electronic control unit comprising at least one CPU (central processing unit) and memory means, said information processing unit comprising at least one function module that can realize a specific function, said at least one CPU controlling the operation of said at least one function module.

2. The computer rearview mirror as claimed in claim 1, further comprising an audio system controllable by said at least one CPU to output voices; wherein said at least one CPU is capable of processing voice commands.

3. The computer rearview mirror as claimed in claim 1, wherein the computer rearview mirror further comprises a video system controllable by said at least one CPU to output image data; said at least one CPU is capable of processing video commands.

4. The computer rearview mirror as claimed in claim 1, wherein said electronic control unit and said information processing unit include a wireless communication circuit; said at least one CPU is capable of using said wireless communication circuit to connect to a wireless local area network and wireless apparatus.

5. The computer rearview mirror as claimed in claim 4, wherein said at least one CPU is capable of using the connected wireless local area network to download audio and video data.

6. The computer rearview mirror as claimed in claim 4, wherein said wireless communication circuit comprises a satellite antenna.

7. The computer rearview mirror as claimed in claim 1, wherein said electronic control unit and said information processing unit include a GPS module adapted to receive satellite signal and determine the geographic location of the car in which the computer rearview mirror is installed, and to control navigation and positioning of the car in which the computer rearview mirror is installed.

8. The computer rearview mirror as claimed in claim 1, wherein said electronic control unit and said information processing unit include a GSM/CDMA module controllable by said at least one CPU to form an on-vehicle telephone and wireless communication system.

9. The computer rearview mirror as claimed in claim 1, wherein said electronic control unit and said information processing unit include a GSM/CDMA module, which is connected thereto communication devices to provide auto-call, traffic management and hand-free functions.

10. The computer rearview mirror as claimed in claim 9, wherein said GSM/CDMA module is connected to an AV input/output interface and a communication interface to form a video telephone for transmitting voices and images to a remote place.

11. The computer rearview mirror as claimed in claim 1, wherein said electronic control unit and said information processing unit include a car data examination module electrically connected to said at least one CPU to provide display, control, examination, data transmission, and real-time handling auto-examination functions.

12. The computer rearview mirror as claimed in claim 1, wherein the computer rearview mirror further comprises a LCD monitor.

13. The computer rearview mirror as claimed in claim 1, wherein the computer rearview mirror further comprises at least one USB port, and the computer rearview mirror can be connectable with memory cards including CF cards, and SD cards.

14. The computer rearview mirror as claimed in claim 1, wherein the computer rearview mirror further comprises storage means and hard disk driver means.

15. The computer rearview mirror as claimed in claim 1, wherein the computer rearview mirror further comprises at least one built-in video camera or at least one attached video camera.

16. The computer rearview mirror as claimed in claim 1, wherein the computer rearview mirror is connectable with a video recording device or a video signal source.

17. The computer rearview mirror as claimed in claim 1, wherein the computer rearview mirror provides a game function to start game programs stored in the memory means of said electronic control unit and to download game programs through a wireless network.

18. The computer rearview mirror as claimed in claim 1, wherein said electronic control unit and said information processing unit include a communication module.

19. The computer rearview mirror as claimed in claim 1, wherein said electronic control unit and said information processing unit include a single chip microcomputer connectable with a temperature sensor, a directional sensor, and a distance sensor.
